(19) United States
(12) Patent Application Publication
(10) Pub. No.: US 2024/0309209 A1
(43) Pub. Date: Sep. 19, 2024

(54) CURABLE POLYSILOXANE COMPOSITION AND OPTICALLY SMOOTH FILMS PREPARED THEREFROM

(71) Applicant: Dow Silicones Corporation, Midland, MI (US)

(72) Inventors: Mary E. Garner, Midland, MI (US); Bradley W. Tuft, Midland, MI (US); Michelle Cummings, Midland, MI (US)

(21) Appl. No.: 18/570,799

(22) PCT Filed: Sep. 19, 2022
(86) PCT No.: PCT/US2022/043968

§ 371 Date: Dec. 15, 2023

Related U.S. Application Data
(60) Provisional application No. 63/249,047, filed on Sep. 28, 2021.

(51) Int. Cl. C08L 83/04; C08J 3/24; C08J 5/18; C08K 5/54

(52) U.S. Cl. CPC C08L 83/04; C08J 3/247; C08J 5/18; C08K 5/5406; G02B 6/0065; C08J 2383/04; C08L 2201/10; C08L 2203/16; C08L 2205/03; C08L 2312/08; C08L 2314/08

(57) ABSTRACT

A curable composition contains: (a) 15 to 73 weight-percent of a vinyl functional M-capped aryl silsesquioxane resin: (b) 0.5 to 5 weight-percent of a vinyl functional disiloxane: (c) 2 to 25 wt % of a silicon-hydride functional M-capped silsesquioxane resin; and (d) 1 to 10 weight parts per million weight parts of platinum from a platinum hydrosilylation catalyst: wherein the sum of the concentration of (a) and (b) is at least 35 weight-percent: weight-percent values are relative to weight of curable composition; and the curable composition is free of acetylenic alcohol hydrosilylation inhibitors.

### FIELD OF THE INVENTION

The present invention relates to a curable polysiloxane composition, methods for curing the curable polysiloxane composition especially into optically smooth films, and optically smooth films made from the curable polysiloxane composition.

### INTRODUCTION

Light-guides are useful for directionally transmitting light from a light emitter to a specific desired location. In contrast to lenses, which transmit light through the thickness dimension of the article, light-guides are used by directing light into an edge of the light-guide article and then internally reflecting the light within the light-guide article as it transmits through the light guide to an opposing edge of the light-guide through the length and/or width dimension of the article. Light-guide articles have stricter requirements for surface roughness and refractive index in order to maximize the light that is maintained within the light-guide article as the light transfers through the light guide. Surface roughness and inadequate refractive index can result in light loss through surfaces of the light guide as light internally reflects off from those surfaces while traveling within the light-guide article. Light can be efficiently directed through tortuous or complex path around other objects within the light-guide and emitted in a desired location. Light-guides are used prevalently in mobile phones, televisions, and display electronics.

Polymethylsiloxanes are not a common light-guide medium due to the higher cost and lower refractive index. Polymethylsiloxanes typically have a refractive index of about 1.4 while more common light-guide materials like polycarbonate (“PC”) and poly(methylmethacrylate) (“PMMA”), typically have a refractive index of greater than 1.5, with refractive index values as measured using 589 nanometer wavelength light at 20 degrees Celsius. It is desirably for the material to have a refractive index of greater than 1.50 to more efficiently translate light within the material as a light-guide. Yet, it is also desirably to use a polysiloxane material as a light-guide medium because they are known for their inherent stability, such as thermal stability.

In certain light-guide applications, the light-guide needs to be a film having a thickness of approximately 25 to 500 micrometers. Examples of such applications include outdoor display electronics, front lit electronic displays, aesthetic or ambient lighting, automotive accent lighting, and other applications where lighting needs to emit from a thin and/or flexible area (that is, a sheet of light). Such films offer their own unique challenges. For instance, the film needs to have opposing primary surfaces that are optically smooth or light can scatter out from the light-guide along the roughness features of the surface. A surface is “optically smooth” if it has a roughness characterized by a value Ra being less than 25 nanometers, where “Ra” is the arithmetic average of feature height encountered in any 1.0 millimeter long line on the surface-except for those areas intentionally roughed to diffuse light out from the surface. A light-guide film can include intentionally roughened patterns such as words or figures to diffuse light out from the light guide and those are intentionally not optically smooth. However, the rest of the film should be optically smooth to minimize light diffusion out from the primary surface in those areas other than where it intentionally is made to diffuse out.

Moreover, the film must cure to a sufficiently high modulus to be handleable, which means it must cure to a stiffness of greater than 15 deciNewtons*meter (dN*m) torque as measured by ASTM D5289-19a. It is further desirable for a curable composition suitable for preparing such a film to have a working time at 25 degrees Celsius (° C.) of at least one hour, where working time is the time required for the composition to double in viscosity.

### BRIEF SUMMARY OF THE INVENTION

The present invention offers a solution to each of the aforementioned problems by providing a curable polysiloxane composition that can be cast and cured into a film that has a refractive index that is 1.50 or greater when measured using 589 nanometer wavelength light at 20 degrees Celsius (° C.), is 25 to 500 micrometers thick, having a surface roughness Ra value of less than 25 nanometers, have a cured stiffness of greater than 15 dN*m. Moreover, the curable composition can form such a film when cured in open air (with a primary surface exposed to air) at temperatures of over 100° C. The curable composition also has a working time at 25° C. of at least one hour.

The solution is a result of discovering a particular combination of polysiloxane materials that can be cast to form a film and then cured by hydrosilylation to achieve a film with the aforementioned properties (“Target Film”). Notably, it is known that by including aryl group on a polysiloxane the index of refraction can be increase even to a value above 1.50. However, it was found during the course of discovering the present invention that aryl-functional polysiloxanes can have a problem with curing to a film with optically smooth primary surfaces when cured at temperature above 100° C. with a primary surface exposed to air. The present invention is a result of discovering particular composition that is capable of curing to optically smooth primary surfaces when exposed to air while also achieving the other properties of the Target Film.

In a first aspect, the present invention is a curable composition comprising:
(a) 15 to 73 weight-percent of a vinyl functional M-capped aryl silsesquioxane resin having a weight-average molecular weight in a range of 700 to 1900 Daltons, and having the average chemical structure (I):

(R₃SiO_{1/2})ₐ(R′SiO_{3/2})_{b}((ZO)ₓR′SiO_{(3-x/2)})_{z} (I)
wherein, at least one R is a terminal alkenyl group with one to 8 carbon atoms, subscript x is independently in each occurrence selected from a value in a range of zero to 2, subscript a is a value in a range of 0.15 to 0.35 and subscript b is a value in a range of 0.65 to 0.85, subscript z is in a range of zero to 0.10 and the sum of subscripts a, b and z is 1.0;
(b) 0.5 to 5 weight-percent of a vinyl functional disiloxane having a weight-average molecular weight in a range of 250-500 Daltons, and having the chemical structure (II):

(R′R₂SiO_{1/2})₂ (II)
wherein at least one R is a terminal alkenyl group with 1 to 8 carbon atoms;
(c) 2 to 25 wt % of a silicon-hydride functional M-capped silsesquioxane resin having a weight-average molecular weight in a range of 500 to 1200 Daltons and having the average chemical structure of (III):

(R″₂HSiO_{1/2})_{c}(R′SiO_{3/2})_{d}(ZO)ₓR′SiO_{(3-x/2)})_{z} (III)
wherein subscript x is independently in each occurrence selected from a value in a range of zero to 2, subscript c has a value in a range of 0.5 to 0.7 and subscript d has a value in a range of 0.3 to 0.5, subscript z is in a range of zero to 0.10, and where the sum of subscripts c, d and z is 1.0;
(d) 1 to 10 weight parts per million weight parts of platinum from a platinum hydrosilylation catalyst based on weight of curable composition;
wherein: R is, subject to requirements stated above, independently in each occurrence selected from a group consisting of alkyl groups with from 1 to 8 carbon atoms and terminal alkenyl groups with from 1 to 8 carbon atoms; R′ is independently in each occurrence selected from aryl groups; R″ is independently in each occurrence selected from alkyl groups with from 1 to 8 carbon atoms; Z is independently in each occurrence selected from a group consisting of hydrogen and alkyl groups and R groups; subscripts a-d and z refer to the mole ratios of the corresponding siloxane unit in the molecule containing the siloxane unit; the sum of the concentration of (a) and (b) is at least 35 weight-percent; weight-percent values are relative to weight of curable composition; and the curable composition is free of acetylenic alcohol hydrosilylation inhibitors.

In a second aspect, the present invention is method for curing the curable composition of the first aspect, the method comprising forming a film of the curable composition then heating the film to a temperature above 100 degrees Celsius to form a cured polymeric film.

In a third aspect, the present invention is cured polymeric film comprising a cured polymeric film of the composition of the first aspect.

Notably, transparent siloxane compositions are known of various compositions for filling mold voids or as coatings over semiconductor elements. However, these applications do not address the challenges of achieving optically flat films of siloxane compositions nor have they identified a composition that can be used to make an optically flat film such as the Target Film described herein.

### DETAILED DESCRIPTION OF THE INVENTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International methods; EN refers to European Norm; DIN refers to Deutsches Institut für Normung; ISO refers to International Organization for Standards; and UL refers to Underwriters Laboratory.

Products identified by their tradename refer to the compositions available under those tradenames on the priority date of this document.

“Multiple” means two or more. “And/or” means “and, or as an alternative”. All ranges include endpoints unless otherwise indicated.

“Alkyl” refers to a hydrocarbon radical derivable from an alkane by removal of a hydrogen atom. An alkyl can be linear or branched.

“Molecular weight”, unless otherwise stated, refers to weight-average molecular weight. Determine weight-average molecular weight of a polymer by gel permeation chromatography (GPC) relative to polystyrene standards. Prepare samples of the polymer for GPC analysis as dilute solutions in toluene and filter the solution using a 0.45 micrometer polytetrafluoroethylene filter prior to analysis. Use high pressure liquid chromatography (HPLC) grade tetrahydrofuran as eluent and run through two Polymer Labs 5-micrometer mixed-C columns maintained at 35° C.

“Refractive index”, or “RI”, is measured for curable compositions using a Rudolph Research Analytical J257 Series Automatic Refractometer equipped with an artificial sapphire prism and light emitting diode (LED) light source. Measure refractive index using 589 nanometer light at 20°° C. For the sake of the compositions herein, the RI for a curable composition is assumed to be equivalent to the RI for the resulting cured polymeric film made using the curable composition so RI values for the cure film correspond to RI values of the curable composition used to make the cured polymeric film. To actually measure RI on a film, use a Metricon Prism Coupler.

“Surface roughness” for a film is characterized by a value “Ra”, which is an arithmetic average of feature height encountered in any 1.0 millimeter long line on the surface as evaluated using a Zygo New View 7300 white light interferometer equipped with a 5x objective.

“Optically smooth” refers to a film that has a surface roughness Ra value of less than 25 nanometers for those surface sections that are not intentionally roughened to diffuse light. Such an Ra value corresponds to the highest gloss standard for injection molded finishing of plastics from the Plastics Industry Association standards SPI A-1.

“Primary surface” of a film refers to a surface having the largest planar surface area, where planar surface area refers to the surface area of the surface projected onto a plane so as to neglect texture of the surface. A film typically has opposing primary surfaces separated by the film's thickness.

“Edge” of a film refers to the outside limit of the film along the dimension of the film joining opposing primary surfaces of the film.

Determine viscosity for the curable compositions at 25° C. using a Brookfield DV-II cone in plate viscometer with a 3º cone (CPA-52Z-Brookfield) and a revolutions per minute value such that torque readings are between 40-60% of the maximum torque value of the rheometer under the given setup.

In one aspect, the present invention is a curable composition. A curable composition is capable of undergoing a curing reaction that crosslinks components of the curable composition. The present invention is capable curing by hydrosilylation reaction of a vinyl functional M-capped aryl silsesquioxane resin, a vinyl functional disiloxane and a silicon-hydride functional M-capped silsesquioxane resin in the presence of a platinum hydrosilylation catalyst.

The vinyl functional M-capped aryl silsesquioxane resin has the following average chemical structure (I):

(R₃SiO_{1/2})ₐ(R′SiO_{3/2})_{b}((ZO)_{X}R′SiO_{(3-x/2)})_{z} (I)

wherein:

R is independently in each occurrence selected from a group consisting of alkyl groups having from one to 8 carbon atoms and alkenyl groups having from one to 8 carbon atoms. In the vinyl functional M-capped aryl silsesquioxane resin, at least one R group, preferably two or more R groups, is/are selected from terminal alkenyl groups having from one to 8 carbon atoms. Preferably, the terminal alkenyl groups for R are vinyl (“Vi”) groups and the alkyl groups are selected from methyl (“Me”), ethyl, and propyl groups.

R′ is independently in each occurrence selected from aryl groups, preferably from a group consisting of phenyl (“Ph”) groups and benzyl groups.

Z is independently in each occurrence selected from hydrogen and R groups, preferably from a group consisting of hydrogen (“H”), methyl and ethyl groups.

Subscript x is independently in each occurrence selected from a value in a range of zero to 2 and can be 0, 1 or 2.

Subscripts a, b, and z refer to the mole ratios of the corresponding siloxane unit in the molecule containing the siloxane unit and the sum of a, b and z is 1.0 for chemical structure (I). Subscript a is a value in a range of 0.15 to 0.35 and can be 0.15 or more, 0.20 or more, 0.25 or more, even 0.30 or more while at the same time is 0.35 or less, and can be 0.30 or less, 0.25 or less, even 0.20 or less. Subscript b is a value in a range of 0.65 to 0.85 and can be 0.65 or more, 0.70 or more, 0.75 or more, even 0.80 or more while at the same time is 0.85 or less, 0.80 or less, 0.75 or less, even 0.70 or less. Subscript z is a value in a range of zero to 0.10 and can be zero or more, even 0.05 or more while at the same time is 0.10 or less and can be 0.05 or less.

Desirably, the vinyl functional M-capped aryl silsesquioxane resin has the following chemical structure: (ViMezSiO_{1/2})ₐ(PhSiO_{3/2})_{b}((ZO)ₓPhSiO_{(3-x/2)})_{z}.

The vinyl functional M-capped aryl silsesquioxane resin has a weight-average molecular weight (Mw) in a range of 700 to 1900 Daltons (Da) and can have a Mw of 700 Da or more, 800 Da or more, 900 Da or more, 1000 Da or more, 1100 Da or more 1200 Da or more, 1300 Da or more, 1400 Da or more, 1500 Da or more, 1600 Da or more, 1700 Da or more, or even 1800 Da or more while at the same time 1900 Da or less, 1800 Da or less, 1700 Da or less, 1600 Da or less, 1500 Da or less, 1400 Da or less, 1300 Da or less, 1200 Da or less, 1100 Da or less, 1000 Da or less, 900 Da or less, or even or less.

The concentration of vinyl functional M-capped aryl silsesquioxane resin in the curable composition is in a range of 15 to 73 weight-percent (wt %), and can be 15 wt % or more, 20 wt % or more, 25 wt % or more, 30 wt % or more, 35 wt % or more, 40 wt % or more, 45 wt % or more, 50 wt % or more, 55 wt % or more, 60 wt % or more, or even 70 wt % or more while at the same time is 73 wt % or less, 70 wt % or less, 65 wt % or less, 60 wt % or less, 55 wt % or less, 50 wt % or less, 45 wt % or less, 40 wt % or less, 35 wt % or less, 30 wt % or less, 25 wt % or less, or even 20 wt % or less, with wt % based on the curable composition weight.

The vinyl functional disiloxane has the following average chemical structure (II):

(R′R₂SiO_{1/2})₂ (II)

wherein R and R′ are as defined herein above, provided that at least one R is a terminal alkenyl group with 1 to 8 carbon atoms. Desirably, the vinyl functional disiloxane has the following chemical structure: (ViMePhSiO_{1/2})₂.

The vinyl functional disiloxane has a Mw in a range of 250 to 500 Da, and can have a Mw of 250 Da or more, 300 Da or more, 350 Da or more, 400 Da or more, or even 450 Da or more while at the same time 500 Da or les, 450 Da or less, 400 Da or less, 350 Da or less, or even 300 Da or less.

The concentration of vinyl functional disiloxane in the curable composition is in a range of 0.5 to 5 wt %, and can be 0.5 wt % or more, 1 wt % or more, 2 wt % or more, 3 wt % or more, or even 4 wt % or more while at the same time is 5 wt % or less, 4 wt % or less, 3 wt % or less, 2 wt % or less, or even 1 wt % or less with wt % relative to curable composition weight provided that the combined concentration of vinyl functional M-capped aryl silsesquioxane resin and vinyl functional disiloxane is 35 wt % or more based on the curable composition weight. The combined concentration of vinyl functional M-capped aryl silsesquioxane resin and vinyl functional disiloxane can, for example, be in a range of 35 wt % to 78 wt %, or put another way 35 wt % or more, 40 wt % or more, 50 wt % or more, 60 wt % or more, or even 70 wt % or more while at the same time 78 wt % or less, 75 wt % or less, 70 wt % or less, 65 wt % or less, 60 wt % or less, 50 wt % or less, even 40 wt % or less with wt % relative to curable composition weight.

The silicon-hydride functional M-capped silsesquioxane resin has the following average chemical structure (III):

(R″2HSiO_{1/2})_{c}(R′SiO_{3/2})_{d}((ZO)ₓR′SiO_{(3-x/2)})_{z} (III)

wherein:
R′, Z, and subscript z are independently in each occurrence as defined herein above;
R″ is independently in each occurrence selected from a group consisting of alkyl groups having from one to 8 carbon atoms and can have one or more, 2 or more, 3 or more, 4 or more, 5 or more, even 6 or more while at the same time 8 or fewer, 7 or fewer, 6 or fewer, 4 or fewer, 3 or fewer, even 2 or fewer carbon atoms;
subscript x is independently in each occurrence selected from a value in a range of zero to 2, and can be 0, 1 or 2;
subscript c has a value in a range of 0.5 to 0.7, and can be in a range of 0.6 to 0.7 or 0.5 to 0.6;
subscript d has a value in a range of 0.3 to 0.5, and can be in a range of 0.3 to 0.4 or 0.4 to 0.4.
and where the sum of subscripts c, d and z is 1.0.

Desirably, the silicon-hydride functional M-capped silsesquioxane resin has the following average chemical structure: (HMe₂SiO_{1/2})_{c}(PhSiO_{3/2})ₐ((ZO)ₓPhSiO_{(3-x/2)})_{z}.

The silicon-hydride functional M-capped silsesquioxane resin has a Mw in a range of 500 to 1200 Da, and can be 500 Da or more, 600 Da or more, 700 Da or more, 800 Da or more, 900 Da or more, 1000 Da or more, or even 1100 Da or more while at the same time is 1200 Da or less, 1100, Da or less, 1000, Da or less, 900 Da or less, 800 Da or less, 700 Da or less, or even 600 Da or less.

The concentration of the silicon-hydride functional M-capped silsesquioxane resin is in a range of 2 to 25 wt %, and can be 2 wt % or more, 3 wt % or more 4 wt % or more, 5 wt % or more, 10 wt % or more, 15 wt % or more, or even 20 wt % or more while at the same time 25 wt % or less, 20 wt % or less, 15 wt % or less, 10 wt % or less, or even 5 wt % or less with wt % relative to curable composition weight.

The platinum hydrosilylation catalyst can be any one or combination of more than one platinum-containing hydrosilylation catalyst. Platinum hydrosilylation catalysts include compounds and complexes such as platinum (0)-1,3-divinyl-1,1,3,3-tetramethyldisiloxane (Karstedt's catalyst), H₂PtCl₆, di-μ.-carbonyl di-.π.-cyclopentadienyldinickel, platinum-carbonyl complexes, platinum-divinyltetramethyldisiloxane complexes, platinum cyclovinylmethylsiloxane complexes, platinum acetylacetonate (acac), platinum black, platinum compounds such as chloroplatinic acid, chloroplatinic acid hexahydrate, a reaction product of chloroplatinic acid and a monohydric alcohol, platinum bis(ethylacetoacetate), platinum bis(acetylacetonate), platinum dichloride, and complexes of the platinum compounds with olefins or low molecular weight organopolysiloxanes or platinum compounds microencapsulated in a matrix or core-shell type structure. The platinum hydrosilylation catalyst can be part of a solution that includes complexes of platinum with low molecular weight organopolysiloxanes that include 1,3-diethenyl-1,1,3,3-tetramethyldisiloxane complexes with platinum. These complexes may be microencapsulated in a resin matrix. The catalyst can be 1,3-diethenyl-1,1,3,3-tetramethyldisiloxane complex with platinum.

The concentration of platinum hydrosilylation catalyst is sufficient to provide a platinum concentration in a range of one to 10 weight parts per million (ppm), and can be one ppm or more, 2 ppm or more 3 ppm or more, 4 ppm or more, 5 ppm or more, 6 ppm or more, 7 ppm or more, 8 ppm or more, or even 9 ppm or more while at the same time 10 ppm or less, 9 ppm or less, 8 ppm or less, 7 ppm or less, 6 ppm or less, 5 ppm or less, 4 ppm or less, 3 ppm or less, or even 2 ppm or less with ppm based on curable composition weight.

Optionally, the curable composition can further comprise a linear alkenyl functional polyorganosiloxane having the average chemical structure (IV):

(R₃SiO_{1/2})ₑ(R′₍₂₋ₓ₎R″ₓ SiO_{2/2})_{f} (IV)

where each R, R′ and R″ are independently selected from the definitions for those groups presented hereinabove; subscript x has an average value in a range of 0 to one; subscript e has a value of 0.03 to 0.97 and can be 0.03 or more, 0.05 or more, 0.10 or more, 0.20 or more, 0.30 or more, 0.40 or more, 0.50 or more, 0.60 or more, 0.70 or more, 0.80 or more, or even 0.90 or more while at the same time is 0.97 or less, 0.95 or less, 0.90 or less, 0.90 or less, 0.80 or less, 0.70 or less, 0.60 or less, 0.50 or less, 0.40 or less, 0.30 or less, 0.20 or less, or even 0.10 or less; and subscript f is chosen such that the sum of subscripts e and f is 1.0.

Desirably, the linear alkenyl functional polyorganosiloxane is selected from one or more component having a chemical structure within the scope of the following two structures: (ViMezSiO_{1/2})ₑ(PhMeSiO_{2/2})f where subscripts e and f are as described hereinabove and (ViMe₂SiO_{1/2})(Ph₂SiO_{2/2})(ViMezSiO_{1/2}).

The concentration of the linear alkenyl functional polyorganosiloxane in the curable composition is in a range of zero to 65 wt %, and can be zero wt % or more, 10 wt % or more, 20 wt % or more, 30 wt % or more, 40 wt % or more, 50 wt % or more, or even 60 wt % or more while at the same time is 65 wt % or less, 65 wt % or less, 55 wt % or less, 45 wt % or less, 40 wt % or less, 35 wt % or less, 25 wt % or less, 15 wt % or less, or even 5 wt % or less with wt % relative to curable composition weight.

At the same time, the curable composition can optionally comprise a silyl hydride functional linear organosiloxane having the average chemical structure (V):

(HR₂SiO_{1/2})₂(R′2SiO_{2/2}) (V)

where R and R′ are each independently in each occurrence as described hereinabove. Desirably, the silyl hydride functional linear organosiloxane has the following chemical structure: (HMezSiO_{1/2})₂(PhPhSiO_{2/2}).

The concentration of the silyl hydride functional linear organosiloxane in the curable composition is in a range of zero to 25 wt %, and can be zero wt % or more, 10 wt % or more, or even 20 wt % or more, while at the same time is 25 wt % or less, 15 wt % or less, or even 5 wt % or less with wt % relative to curable composition weight.

Desirably, the curable composition has a molar ratio of silicon hydride functionality (SiH) to terminal alkenyl groups that is in a range of 0.8 to 3.0, and can be 0.8 or more, 0.9 or more, 1.0 or more, 1.2 or more, 1.4 or more, 1.6 or more, 1.8 or more, 2.0 or more, 2.2 or more, 2.4 or more, 2.6 or more, or even 2.8 or more while at the same time is desirably 3.0 or less, 2.9 or less, 2.7 or less, 2.5 or less, 2.3 or less, 2.1 or less, 1.9 or less, 1.7 or less, 1.5 or less, 1.3 or less, 1.1 or less, or even 1.0 or less. Determine SiH to terminal alkenyl group molar ratio by proton nuclear magnetic resonance (1H NMR) spectroscopy. Prepare samples for analysis by combining a known amount of sample with a known amount of an internal standard (1,4-dioxane) in deuterated chloroform. Collect spectra using an Aligent 400-MR NMR instrument equipped with a 5 millimeter ONeNMR probe. Analyze data using MesReNova x64 software. Calculate weight percentages of terminal alkenyl and SiH groups by integrating the relevant proton resonances against those of the internal standard.

Desirably, the curable composition is free of siloxane molecules that contain more than 3 mole-percent (mol %), preferably 2 mol % or more, even more preferably 1 mol % or more epoxy-containing groups relative to moles of silicon atoms in the siloxane molecules.

Desirably, the curable composition has a refractive index (RI) at 589 nanometers that is 1.50 or greater, preferably greater than 1.50.

In another aspect, the present invention is a method for curing the curable composition of the present invention into a cured polymeric film. The method comprising forming a film of the curable composition and then heating the film to a temperature above 100 degrees Celsius (° C.), preferably 120° C. or more, even more preferably 130° C. or more, to cure the film into a cured polymeric film. The curable composition can be formed into a film by any method such as spin coating onto a substrate, or casting it into a film using a draw down bar, doctor blade (or any knife blade), or slot die. For example, the curable composition can be spin coated onto a silicon wafer, preferably an optically smooth silicon wafer. Alternatively, the curable composition can be disposed onto a substrate, preferably an optically smooth substrate, with the film thickness controlled by a slot die physical offset or by passing the curable composition on the substrate under a blade or knife with the thickness controlled by a gap between a blade or knife edge and the substrate.

Film thickness prior and particularly after curing is desirably in a range of 25 to 500 micrometers, and can be 25 micrometers or more, 50 micrometers or more, 75 micrometers or more, 100 micrometers or more, 150 micrometers or more, 200 micrometers or more, 250 micrometers or more, 300 micrometers or more, 350 micrometers or more, 400 micrometers or more, or even 450 micrometers or more while at the same time is desirably 500 micrometers or less, 475 micrometers or less, 425 micrometers or less, 375 micrometers or less, 325 micrometers or less, 275 micrometers or less, 225 micrometers or less, 175 micrometers or less, 125 micrometers or less, 75 micrometers or less, or even 50 micrometers or less. Determine film thickness according to ASTM D1005 Procedure C 6.3.6 using a handheld digital micrometer (Mitutoyo 547-526S).

While one primary surface of the film of curable composition is in contact with a substrate surface the opposing primary surface can be exposed to air. Even when exposed to air, the exposed primary surface of the film can cure to an optically smooth surface. Moreover, when cured on a substrate with an optically smooth surface, the resulting cured polymeric film can have opposing primary surfaces that are both optically smooth. Notably, intentional patterning can be imprinted or imparted onto some or all of a primary surface while retaining an optically smooth surface with the intentional patterning is absent.

The cured polymeric film has a stiffness of 15 deciNewtons*meters (dN*m) or more, and can have a stiffness of 20 dN*m or more, 25 dN*m or more, 30 dN*m or more, 35 dN*m or more, 40 dN*m or more, 45 dN*m or more, 50 dN*m or more, 55 dN*m or more, 60 dN*m or more, 65 dN*m or more, 70 dN*m or more, 75 dN*m or more, 80 dN*m or more, 85 dN*m or more, or even 90 dN*m or more while at the same time typically has a stiffness of 150 dN*m or less, 100 dN*m or less, 75 dN*m or less, or even 50 dN*m or less.

The cured polymeric film can be part of an article where the cured polymeric film further comprises a light source coupled with the film in such a way so as to direct light into an edge of the film. The cured polymeric film of the present invention is particularly useful as a light-guide, particularly one where light is directed into an edge of the film and transmitted within the film to other edges of the film and optionally out from patterned portions of one or more primary surface of the film. In such an application, the film is “coupled” with a light source that directs light into an edge of the film. Coupling can occur by direct contact with a light emitting source or by indirect coupling through fiber optic or other waveguide materials that are transmitting light from a light emitting source.

### EXAMPLES

Table 1 lists the materials for the following examples.

TABLE 1

| Component | Description | Source |
|---|---|---|
| A | Vinyl functional M-capped aryl silsesquioxane resin | Prepare according to |
| | having a Mw of 1520 Da and the following average | teachings in |
| | chemical structure: (ViMe₂SiO_{1/2})_{0.25}(PhSiO_{3/2})_{0.75} | U.S. Pat. No. 7863392B2. |
| B | Vinyl functional disiloxane having a Mw of 310 Da and | Available from TCI |
| | the following average chemical structure: | Chemicals as product |
| | ViMePhSiOSiMePhVi | D5557. |
| C | Silicon-hydride functional M-capped silsesquioxane resin | Prepare according to |
| | having a Mw of 740 Da and the following average | teachings in |
| | chemical structure: | U.S. Pat. No. 7863392B2 |
| | (HMe₂SiO_{1/2})_{(0.6-y/2)}(PhSiO_{3/2})_{(0.4-y/2)}[(OZ)(Ph)SiO_{(3-x)/2}]_{y} | |
| | Where Z is selected from hydrogen and alkyl groups, x is | |
| | one or 2 and y is 0.02-0.05. | |
| D | Platinum hydrosilylation catalyst: platinum (0)-1,3- | Aldrich |
| | divinyl-1,1,3,3-tetramethyldisiloxane in isopropanol | |
| E1 | Linear alkenyl functional polyorganosiloxane having an | Available from Gelest |
| | Mw of 2600 Da and the following average chemical | under the name PMV- |
| | structure: (ViMe₂SiO_{1/2})₂(PhMeSiO_{2/2})₂₅ | 9925. |
| E2 | Linear alkenyl functional organosiloxane 1,5-divinyl-3,3- | Available from Gelest |
| | diphenyl-1,1,5,5-tetramethyltrisiloxane having an Mw of | under the name |
| | 380 Da. | SID4609.0. |
| F | Silyl hydride functional linear organosiloxane: 1,1,5,5- | Available from TCI |
| | tetramethyl-3,3,diphenyltrisiloxane having a Mw of 332 | Chemicals as product |
| | Da. | T3832 |
| Inhibitor | 2-Phenyl-3-butyn2-ol (PBO) | Available from Sigma- |
| | | Aldrich |

Prepare curable compositions by combining the components of the composition as indicated in the following tables (component amounts shown in grams) into a container, mixing by hand with a metal spatula and then mixing at 3500 revolutions per minute for 30 seconds with a speed mixer. Determine the RI for the curable composition. Also determine the working time for the curable compositions by measuring viscosity initially after making and subsequently measuring every 15 minutes to determine how long it takes for the viscosity to double-which corresponds to the working time of the curable composition.

Prepare films of the curable compositions by depositing 2-4 grams of a curable composition onto an optically smooth silicon wafer (100 millimeter or 150 millimeter diameter Pure Wafer, boron doped silicone, test grade, 0.5 millimeter thick, root mean square surface roughness is less than 1 nanometer) and then spin coat the curable composition over the wafer using a Cost Effective Equipment spin coater at 500-1000 revolutions per minute for 60 seconds to achieve a uniform thin film of a thickness of 25-500 micrometers.

Cure films of the curable composition by transferring the wafer containing the film onto a hot pate set at 130°° C. for 5 minutes in the open air then allow the cured film to cool. Determine thickness of the cured film according to ASTM D1005 Procedure C 6.3.6 using a handheld digital micrometer (Mitutoyo 547-526S). Evaluate surface roughness of the exposed primary surface.

The following tables provide the recipes for the curable compositions and characterization results for those curable compositions.

Compositions of the present invention demonstrate an ability to form a cured polymeric film having an RI of >1.5 at 589 nanometers, an Ra value of <24 nanometers for its exposed cured surface, and a thickness of 25-500 micrometers as well as a stiffness of >15 dN*m and working time of over one hour.

Exs A-G reveal that without the silicon-hydride functional M-capped silsesquioxane resin the cured film exhibits unacceptable surface roughness.

Exs H-J reveal that curable compositions with <35 wt % of a combination of vinyl functional M-capped aryl silsesquioxane resin and vinyl functional disiloxane result in a cured film that do not achieve a stiffness of >15dN*m.

Ex K reveals that >1.9 wt % of silicon-hydride functional M-capped silsesquioxane resin is required to achieve a stiffness of >15dN*m.

Ex L and Ex 1 reveal that >15 wt % vinyl functional M-capped aryl silsesquioxane resin is necessary for the cured film to achieve a stiffness of >15dN*m.

Exs M-O and Ex 9-11 reveal that without the vinyl functional disiloxane component the curable composition has a working time of less than 60 minutes.

Ex P and Ex 12 reveal that the invention must be free of acetylenic alcohol hydrosilylation inhibitors in order to achieve an optically smooth surface on the exposed cured film surface.

Exs 12-16 reveal that linear alkenyl functional polyorganosiloxane having alkyl-aryl or diaryl substituents on the polymer backbone can be used separately or as a blend in the composition and produce desirable film properties.

Ex 1-16 are “Optically Clear”. “Optical clarity” refers to a transmittance greater than 80% for light at 400 nanometers (nm) and a transmittance ratio for transmittance at 400 nm divided by transmittance at 800 nm (“% T(400/800)”) that is greater than 0.7. Measure transmittance with an ultraviolet/visible (UV/Vis) dual beam spectrophotometers (Perkin Elmer Lambda 950) according to the method of ASTM D1003 over a wavelength range of 400-800 nm. Prepare samples for measuring transmittance by mixing the reactive composition precursor by hand and then at 3500 revolutions per minute for 30 seconds in a speed mixer and cure at 80° C. for 12 hours. Cure samples between glass slides to produce samples with optically smooth surfaces with a thickness of 10 millimeters.

For Example, Ex 4 has a percent transmittance (% T) at 400 nm of 85.1 and % T(400/800) of 0.95; Ex 8 has a percent transmittance (% T) at 400 nm of 86.7 and % T(400/800) of 0.95; Ex 10 has a percent transmittance (% T) at 400 nm of 87.9 and % T(400/800) of 0.98; Ex 13 has a percent transmittance (% T) at 400 nm of 88.0 and % T(400/800) of 0.98; Ex 14 has a percent transmittance (% T) at 400 nm of 88.5 and % T(400/800) of 0.98; Ex 15 has a percent transmittance (% T) at 400 nm of 89.0 and % T(400/800) of 0.98; and Ex 16 has a percent transmittance (% T) at 400 nm of 88.0 and % T(400/800) of 0.99.

TABLE 2

| Component | Ex A | Ex B | Ex C | Ex D | Ex E | Ex F | Ex G | Ex H |
|---|---|---|---|---|---|---|---|---|
| A | 58.8 | 60.4 | 61.9 | 63.2 | 65.2 | 66.5 | 73.3 | 0.0 |
| B | 1.0 | 1.0 | 1.0 | 1.0 | 1.0 | 1.0 | 1.0 | 1.0 |
| C | 0.0 | 0.0 | 0.0 | 0.0 | 0.0 | 0.0 | 0.0 | 4.7 |
| D | 0.01 | 0.01 | 0.01 | 0.01 | 0.01 | 0.01 | 0.01 | 0.01 |
| E1 | 10.0 | 10.0 | 9.9 | 10.0 | 10.0 | 0.0 | 0.0 | 89.5 |
| F | 30.2 | 28.6 | 27.2 | 25.8 | 23.8 | 32.5 | 25.7 | 4.7 |
| Inhibitor | 0 | 0 | 0 | 0 | 0 | 0 | 0 | 0 |

Characteristics

| Film | 60 | 60 | 110 | 120 | 130 | 50 | 80 | 50 |
|---|---|---|---|---|---|---|---|---|
| Thickness | | | | | | | | |
| (micrometers) | | | | | | | | |
| Working | >60 | >60 | >60 | >60 | >60 | >60 | >60 | >60 |
| Time | | | | | | | | |
| (minutes) | | | | | | | | |
| Surface | 74 | 32 | 26 | 30 | 67 | 42 | 36 | <1 |
| Roughness Rₐ | | | | | | | | |
| (nanometers) | | | | | | | | |
| RI | 1.54 | 1.54 | 1.54 | 1.54 | 1.54 | 1.54 | 1.54 | 1.54 |
| Stiffness | 0.24 | 1.8 | 9.7 | 18.9 | 21.8 | 0.95 | 27.4 | 4 |
| (dN*m) | | | | | | | | |
| Component | Ex I | Ex J | Ex K | Ex L | Ex M | Ex N | Ex O | Ex P |
| A | 0.0 | 29.2 | 45.5 | 10.8 | 71.9 | 71.8 | 67.6 | 63.2 |
| B | 1.0 | 1.0 | 1.0 | 1.0 | 0 | 0.1 | 5.2 | 1 |
| C | 6.9 | 5.6 | 1.9 | 25.0 | 14.3 | 14.3 | 13.9 | 13.5 |
| D | 0.01 | 0.01 | 0.01 | 0.01 | 0.01 | 0.01 | 0.01 | 0.01 |
| E1 | 89.6 | 52.4 | 31.3 | 63.2 | 0 | 0 | 0 | 9.2 |
| F | 2.5 | 11.8 | 20.3 | 0.0 | 13.8 | 13.8 | 13.3 | 13.1 |
| Inhibitor | 0 | 0 | 0 | 0 | 0 | 0 | 0 | 0.05 |
| | Characteristics | | | | | | | |
| Film | 50 | 70 | 110 | 90 | NA | 120 | 140 | 110 |
| Thickness | | | | | | | | |
| (micrometers) | | | | | | | | |
| Working | >60 | >60 | >60 | >60 | <10 | <15 | >60 | >60 |
| Time | | | | | | | | |
| (minutes) | | | | | | | | |
| Surface | <1 | <1 | <1 | 5 | NA | 1 | 32 | 103 |
| Roughness Rₐ | | | | | | | | |
| (nanometers) | | | | | | | | |
| RI | 1.54 | 1.54 | 1.54 | 1.54 | 1.54 | 1.54 | 1.54 | 1.54 |
| Stiffness | 6.9 | 14.0 | 9.3 | 5.1 | 98 | 90 | 45 | 49.6 |
| (dN*m) | | | | | | | | |

NA - could not characterize, cured too quickly before film could be made.

TABLE 3

| | Ex | Ex | Ex | Ex | Ex | Ex | Ex | Ex |
|---|---|---|---|---|---|---|---|---|
| Component | 1 | 2 | 3 | 4 | 5 | 6 | 7 | 8 |
| A | 16.2 | 29.2 | 27.3 | 62.2 | 37.8 | 37.1 | 71.4 | 63.3 |
| B | 1.0 | 1.0 | 1.0 | 1.0 | 1.0 | 1.0 | 1.0 | 1.0 |
| C | 20.2 | 8.9 | 16.3 | 3.5 | 7.2 | 18.9 | 2.6 | 13.5 |
| D | 0.01 | 0.01 | 0.01 | 0.01 | 0.01 | 0.01 | 0.01 | 0.01 |
| E1 | 62.6 | 52.3 | 55.5 | 9.7 | 41.8 | 43.0 | 0.0 | 9.2 |
| E2 | 0 | 0 | 0 | 0 | 0 | 0 | 0 | 0 |
| F | 0.0 | 8.6 | 0.0 | 23.7 | 12.2 | 0.0 | 25.0 | 13.1 |

Characterization

| Film | 110 | 60 | 100 | 90 | 80 | 90 | 110 | 110 |
|---|---|---|---|---|---|---|---|---|
| Thickness | | | | | | | | |
| (micrometers) | | | | | | | | |
| Working | >60 | >60 | >60 | >60 | >60 | >60 | >60 | >60 |
| Time | | | | | | | | |
| (minutes) | | | | | | | | |
| Surface | 7 | 4 | <1 | <1 | <1 | <1 | 5 | <1 |
| Roughness Rₐ | | | | | | | | |
| (nanometers) | | | | | | | | |
| RI | 1.54 | 1.54 | 1.54 | 1.54 | 1.54 | 1.54 | 1.54 | 1.54 |
| Stiffness | 18.6 | 23.1 | 43.9 | 18.4 | 24.3 | 57 | 33 | 60.5 |
| (dN*m) | | | | | | | | |
| | Ex | Ex | Ex | Ex | Ex | Ex | Ex | Ex |
| Component | 9 | 10 | 11 | 12 | 13 | 14 | 15 | 16 |
| A | 70.0 | 71.2 | 68.3 | 63.3 | 55.4 | 51.5 | 62.3 | 52 |
| B | 0.5 | 1 | 4.2 | 1 | 1 | 1 | 1 | 1 |
| C | 14.6 | 14.2 | 14 | 13.5 | 15.1 | 17.1 | 15.0 | 17.1 |
| D | 0.01 | 0.01 | 0.01 | 0.01 | 0.01 | 0.01 | 0.01 | 0.01 |
| E1 | 0 | 0 | 0 | 9.2 | 4.4 | 4.1 | 0 | 0 |
| E2 | 0 | 0 | 0 | 0 | 12.6 | 15.7 | 10.3 | 17.8 |
| F | 14 | 13.7 | 13.5 | 13.1 | 11.3 | 10.5 | 11.4 | 12.1 |
| | Characterization | | | | | | | |
| Film | 110 | 120 | 100 | 110 | 110 | 80 | 90 | 80 |
| Thickness | | | | | | | | |
| (micrometers) | | | | | | | | |
| Working | >60 | >60 | >60 | >60 | >60 | >60 | >60 | >60 |
| Time | | | | | | | | |
| (minutes) | | | | | | | | |
| Surface | 1 | <1 | <1 | 1 | 2 | 4 | 2 | <1 |
| Roughness Rₐ | | | | | | | | |
| (nanometers) | | | | | | | | |
| RI | 1.54 | 1.54 | 1.54 | 1.54 | 1.54 | 1.54 | 1.54 | 1.54 |
| Stiffness | 90 | 98 | 70 | 60.5 | 40 | 37 | 51 | 19 |
| (dN*m) | | | | | | | | |

1. A curable composition comprising:
(a) 15 to 73 weight-percent of a vinyl functional M-capped aryl silsesquioxane resin having a weight-average molecular weight in a range of 700 to 1900 Daltons, and having the average chemical structure (I):
(R₃SiO_{1/2})ₐ(R′SiO_{3/2})_{b}((ZO)ₓR′SiO_{(3-x/2)})_{z} (I)
wherein, at least one R is a terminal alkenyl group with one to 8 carbon atoms, subscript x is independently in each occurrence selected from a value in a range of zero to 2, subscript a is a value in a range of 0.15 to 0.35 and subscript b is a value in a range of 0.65 to 0.85, subscript z is in a range of zero to 0.10 and the sum of subscripts a, b and z is 1.0;
(b) 0.5 to 5 weight-percent of a vinyl functional disiloxane having a weight-average molecular weight in a range of 250-500 Daltons, and having the chemical structure (II):
(R′R₂SiO_{1/2})₂ (II)
wherein at least one R is a terminal alkenyl group with 1 to 8 carbon atoms;
(c) 2 to 25 wt % of a silicon-hydride functional M-capped silsesquioxane resin having a weight-average molecular weight in a range of 500 to 1200 Daltons and having the average chemical structure of (III):
(R″₂HSiO_{1/2})(R′SiO_{3/2})ₐ(ZO)ₓR′SiO_{(3-x/2)})_{z} (III)
wherein subscript x is independently in each occurrence selected from a value in a range of zero to 2, subscript c has a value in a range of 0.5 to 0.7 and subscript d has a value in a range of 0.3 to 0.5, subscript z is in a range of zero to 0.10, and where the sum of subscripts c, d and z is 1.0;
(d) 1 to 10 weight parts per million weight parts of platinum from a platinum hydrosilylation catalyst based on weight of curable composition,
wherein:
R is, subject to requirements stated above, independently in each occurrence selected from a group consisting of alkyl groups with from 1 to 8 carbon atoms and terminal alkenyl groups with from 1 to 8 carbon atoms; R′ is independently in each occurrence selected from aryl groups; R″ is independently in each occurrence selected from alkyl groups with from 1 to 8 carbon atoms; Z is independently in each occurrence selected from a group consisting of hydrogen and alkyl groups and R groups; subscripts a-d and z refer to the mole ratios of the corresponding siloxane unit in the molecule containing the siloxane unit; the sum of the concentration of (a) and (b) is at least 35 weight-percent; weight-percent values are relative to weight of curable composition; and the curable composition is free of acetylenic alcohol hydrosilylation inhibitors.

2. The curable composition of claim 1, wherein the curable composition further comprises greater than zero weight-percent and at the same time 65 weight-percent or less of a linear alkenyl functional polyorganosiloxane having a weight-average molecular weight in a range of 300 to 9000 Daltons and chemical structure (IV):
(R₃SiO_{1/2})ₑ(R′₍₂₋ₓ₎R″ₓ SiO_{2/2})_{f} (IV)
where R is independently in each occurrence selected from alkyl and terminal alkenyl groups having from one to 8 carbon atoms provided that at least one R in each (R₃SiO_{1/2}) unit is a terminal alkenyl group, R′ is selected from aryl groups, and R″ is selected from alkyl groups that have from one to 8 carbon atoms, subscript x has an average value in a range of 0 to one, subscript e has a value of 0.03 to 0.97, subscripts e and f are mole ratios of the associated siloxane unit in the molecule containing the siloxane unit, the sum of the values for subscript e and f is 1.0 and weight-percent is relative to curable composition weight.

3. The curable composition of claim 1, wherein the curable composition further comprises greater than zero weight-percent and at the same time 25 weight-percent of a silyl hydride functional linear organosiloxane having a weight-average molecular weight in a range of 250-500 Daltons and having the chemical structure (V):
(HR₂SiO_{1/2})₂(R′₂SiO_{2/2}) (V)
where R is independently in each occurrence selected from alkyl groups having from one to 8 carbon atoms and R′ is selected from aryl groups.

4. The curable composition of any . . . claim 1, wherein the molar ratio of SiH to terminal alkenyl groups is in a range of 0.8 to 3.0.

5. The curable composition of any claim 1, wherein:
(i) chemical structure (I) has the following chemical structure: (ViMe₂SiO_{1/2})ₐ(PhSiO_{3/2})_{b}((ZO)ₓPhSiO_{(3-x/2)})_{z};
(ii) chemical structure (II) has the following chemical structure: (ViMePhSiO_{1/2})₂;
(iii) chemical structure (III) has the following chemical structure: (HMezSiO_{1/2})_{c}(PhSiO_{3/2})_{d}((ZO)ₓPhSiO_{(3-x/2)})_{z};
(iv)chemical structure (IV), when present, has the following chemical structure: (ViMezSiO_{1/2})ₑ(PhMeSiO_{2/2})f;
(v) chemical structure (V), when present, has the following chemical structure: (HMezSiO_{1/2})₂(PhPhSiO_{2/2}); and
where “Vi” refers to a vinyl group, “Ph” refers to a phenyl group, and “Me” refers to a methyl group.

6. The curable composition of claim 1, wherein the curable composition is free of siloxane molecules that contain greater than 3 mol % of epoxy-containing groups relative to moles of silicon atoms in the siloxane molecules.

7. A method for curing the curable composition of claim 1, the method comprising forming a film of the curable composition then heating the film to a temperature above 100 degrees Celsius to form a cured polymeric film.

8. A cured polymeric film comprising a cured polymeric film of the composition of claim 1.

9. The cured polymeric film of claim 8, wherein the film is characterized by having a refractive index of 1.50 or greater when measured using 589 nanometer wavelength light, a thickness in a range of 25-500 micrometers and wherein the film has an optically smooth primary surface.

10. The cured polymeric film of claim 8, the film further comprising a light source coupled with the film in such a way so as to direct light into an edge of the film.
